(19) United States
(12) Patent Application Publication
(10) Pub. No.: US 2024/0232942 A1
(43) Pub. Date: Jul. 11, 2024

(54) METHOD AND APPARATUS FOR DELIVERY OF SERVICES

(71) Applicant: Arthur L. Burris, JR., Peoria, AZ (US)

(72) Inventor: Arthur L. Burris, JR., Peoria, AZ (US)

(21) Appl. No.: 18/094,242

(22) Filed: Jan. 6, 2023

(51) Int. Cl. G06Q 30/0251; G06Q 30/0201

(52) U.S. Cl. CPC G06Q 30/0254; G06Q 30/0206

(57) ABSTRACT

The system provides a digital solution for access to service providers, with a personalized user experience, reduced fees, and better choice. The system builds customer loyalty, optimizes time, and uses predictive analytics to improve performance. The system uses a combination of personalization, artificial intelligence, reduced fees, and advanced analytics to provide personalized services. The system provides better services for consumers and better experiences for providers.

### BACKGROUND OF THE SYSTEM

The nature of commerce changed dramatically with the evolution of e-commerce. Digital stores have surpassed physical stores (so-called “brick and mortar”) in total sales and engagement. Consumers have taken to “showrooming” which is the inspection of items at a physical store before purchasing the item online. This has had a profound impact on the nature of business and the lives of consumers. The ability to compare shop has provided a downward pressure on prices in both the physical and digital world. Physical stores can offer instant gratification (no need to wait for delivery) but must set a price that approximates that of digital vendors.

One area that hasn't been as easy to integrate into the digital world is that of service providers of the type that require an in person visit, such as physicians, hair stylists, aestheticians, and the like. Although service providers advertise on the internet and in the digital world, the basic consumer/provider interaction is not much different than it was in the pre-digital world.

Consumers would like the ease of digital interaction that other industries provide but have been unable to find a solution for service providers. Attempts to provide digital service provider platforms have a number of disadvantages for consumers. There are too many service providers to choose from, trust issues and unreliability, lack of professionalism, lack of accountability, safety concerns, lack of vetting, Similarly, there are a number of disadvantages for the service providers themselves, including financial exploitation, system surcharges, lack of direct access to customers, inability to schedule recurring services with customers, and high service fees.

### SUMMARY

The system provides a digital solution for access to service providers, with a personalized user experience, reduced fees, and better choice. The system builds customer loyalty, optimizes time, and uses predictive analytics to improve performance. The system uses a combination of personalization, artificial intelligence, reduced fees, and advanced analytics to provide personalized services. The system provides better services for consumers and better experiences for providers.

### BRIEF DESCRIPTION OF THE DRAWINGS

FIG. 1 is a flow diagram illustrating enrollment of a service provider in an embodiment of the system.

FIG. 2 is a flow diagram illustrating a service request from the service provider side in an embodiment of the system.

FIG. 3 is a flow diagram illustrating a service request by a consumer in an embodiment of the system.

FIG. 4 is a flow diagram illustrating the predictive analytics in an embodiment of the system.

FIG. 5 illustrates embodiments of the consumer facing app of the system.

FIG. 6 illustrates embodiments of the service provider facing app of the system.

### DETAILED DESCRIPTION OF THE SYSTEM

In the prior art, when a consumer wishes to use digital tools to engage with a service provider, the consumer will do a search to find a provider, and then schedule an appointment either with a phone call or perhaps through a scheduling service on the provider website. Then the user would go to a service provider location for the requested service. For example, the consumer would go to a hair salon for a haircut.

A service provider may use the digital world as an advertising medium to attract new customers. The service provider may take advantage of Search Engine Optimization (SEO), ad-sense, keywords, and the like. For some providers on a more limited budget, the provider may only advertise on free sites such as Craigslist.org and the like.

An individual service provider lacks the economic power to fully take advantage of the digital world. The prior art has attempted to solve the problem by having a website where multiple service providers can participate and take advantage of large scale advertising. A disadvantage of such systems is that each service provider typically must pay a subscription fee to participate in the service. In addition, a service provider must pay for leads of customers. Often the leads are expensive and are not good leads that translate into paying customers. If a customer does engage, the service provider must pay a commission to the website on the transaction. In addition, the rules of some websites prevent the service provider from setting up repeat appointments with the same customer outside of the website system, requiring continuous payment of commissions.

One example of such a prior art system is called Thumbtack found at https://www.thumbtack.com/. In this system, the service professionals must pay credits to contact customers and provide a quote for desired services. The service professional is not guaranteed to get the assignment but must pay the credit anyway. The number of credits required depends on the value of the job, with more expensive jobs costing more credits. In addition, the prior art systems charge a commission on each job obtained by the service provider and also charges a fee for credit card transactions.

The present system solves disadvantages of prior art systems and provides improved service for customers and an improved environment for service providers. The present system provides a method and apparatus to connect consumers and service providers to transact commerce anytime and anywhere. The system has a service provider component and a consumer component. The system provides a platform for service providers in the fields of beauty and personal care, home and garden, health and wellness, food and beverage, automotive and transport, pets and animals, and the like.

### Service Provider Component

The system provides a flat rate monthly subscription package for service providers. This solves the bid for job problem and allows the service providers to bid on every job without financial hits. In one embodiment, the system does not charge the service provider for credit card transactions but instead covers those fees out of the monthly subscription package. The system permits the vendor to schedule recurring services, open correspondence with customers. The system uses predictive analytics to provide better performance and to increase consumer engagement.

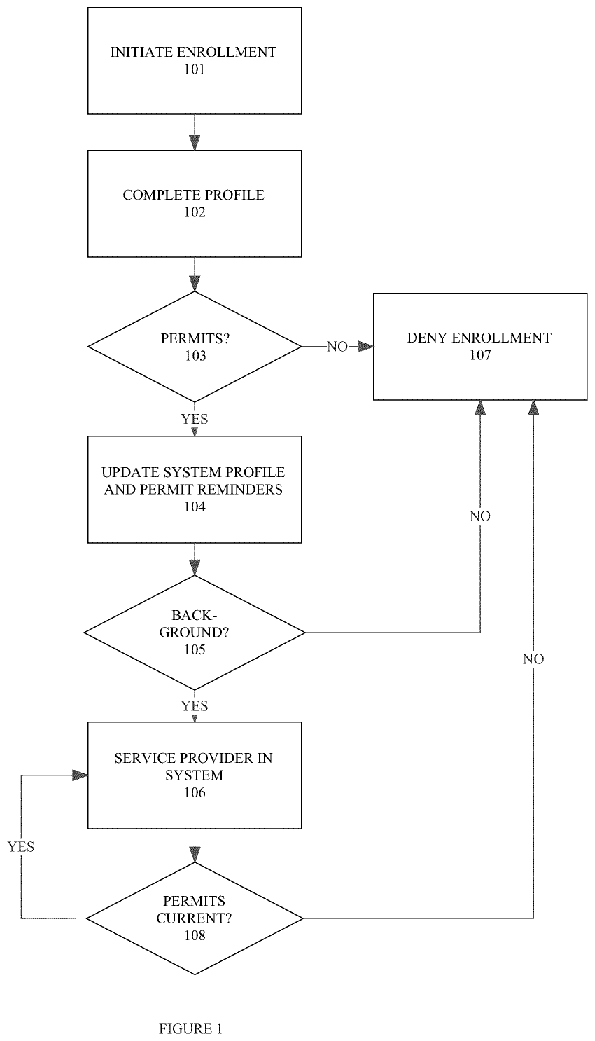

FIG. 1 is a flow diagram illustrating the process for enrolling service providers in an embodiment of the system. At step 101 the provider initiates the enrollment process via a system dashboard. At step 102 the providers completes a profile that includes name, profession, location, prices, specialties, and the like. At decision block 103 the system checks its database for the associated profession to determine what permits are required for the service provider and at decision block 103 requests proof of permits from the service provider.

If the service provider does not produce the required permits, the system denies enrollment at step 107 and the system returns to step 101 where the service provider can reapply if desired. If the permits are provided at step 103, the system proceeds to step 104 and enters the permits and profile of the service provider into the system. At this point, the system generates reminders regarding any permits that require renewal or updating so that the system can confirm future permitting status.

At decision block 105 the system performs a background check on the service provider. This is to ensure the quality of the members of the service provider population and to protect the consumers of the system. If the service provider fails the background check, enrollment is denied at step 107. If the service provider passes the background check at step 105, the service provider is enrolled in the system at step 106.

At decision block 108, the system checks permit and license status in cases where the same require a renewal. If the service provider has maintained all credentials, the system returns to step 106 and the service provider remains in the system. If the service provider does not have required credentials at step 108, the system proceeds to step 107 and the system denies enrollment to the service provider. This protects the public from un-credentialed service providers.

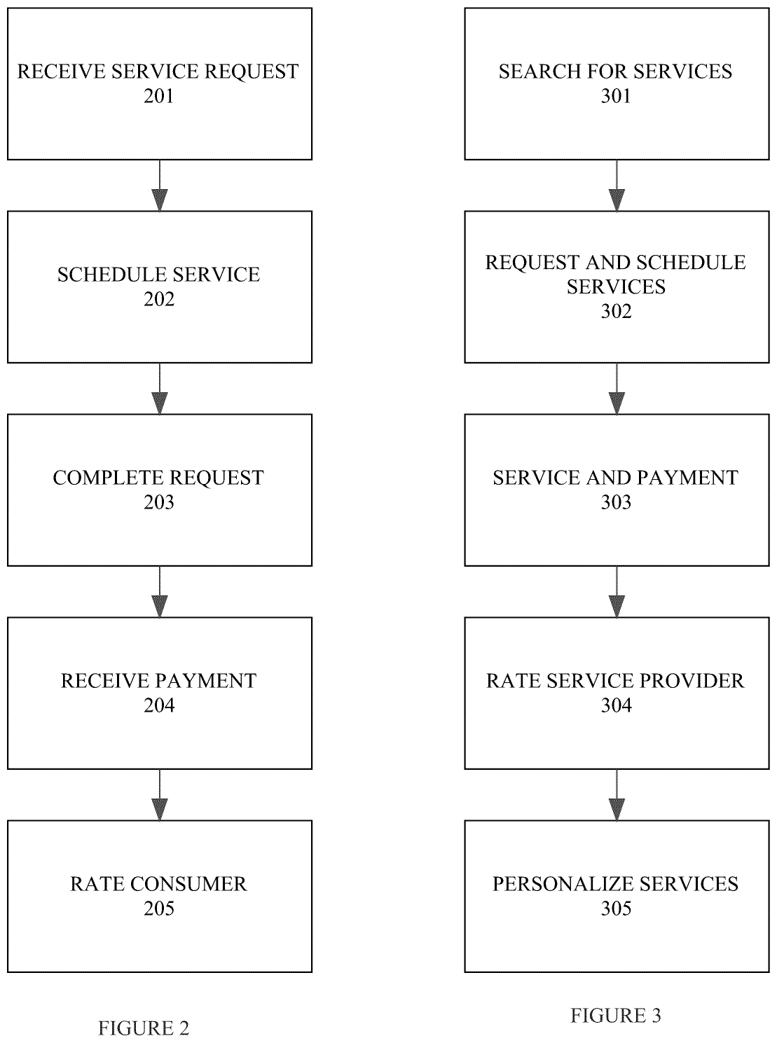

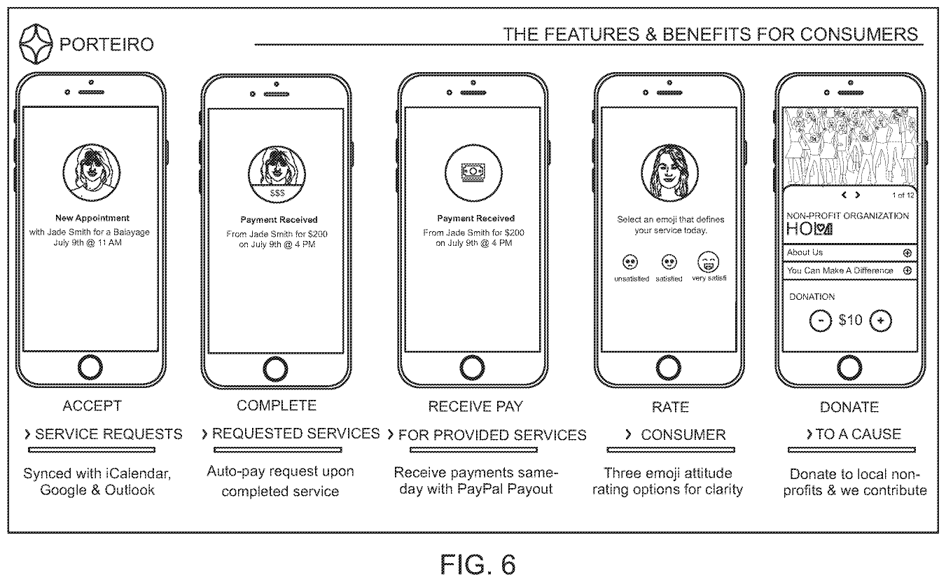

The system acts as a digital staff for service providers, scheduling appointments, handling payment, finding leads, advertising, provider and customer ratings, and the like. FIG. 2 is a flow diagram illustrating the operation of the system for a service provider in an embodiment. At step 201, the service provider receives a request for service from a consumer. At step 202 the service is scheduled. The scheduling of the service may be done automatically by the system. For example, the service provider can have their calendar system synchronized with the system calendar. In one embodiment, the service provider uses a calendar of the system and all appointments are maintained by the system. The service provider defines times of availability and length of time required for requested services. The system can then find open blocks and offer them to the requesting consumer, who then selects the desired time. FIG. 6 is an illustration of embodiments of the service provider facing app on a smartphone or other device.

At step 203 the service provider provides the requested service at the appropriate time. At step 204 the service provider receives payment from the system. Any commission to be charged is based on the subscription plan selected by the service provider. In addition, credit card fees are borne by the system, not the service provider. This encourages the use of a larger number of credit cards, increasing ease of use for the consumer. In the prior art, some businesses do not accept certain credit cards because of higher processing fees. At step 205, the service provider rates the consumer. This rating may be kept confidential by the system and not viewable by the consumer. This rating may aid in improving the efficiency of the system for the service provider and the consumer as well.

After every service transaction, data is provided to the system performance analytics engine to monitor performance and customer satisfaction.

### Consumer Component

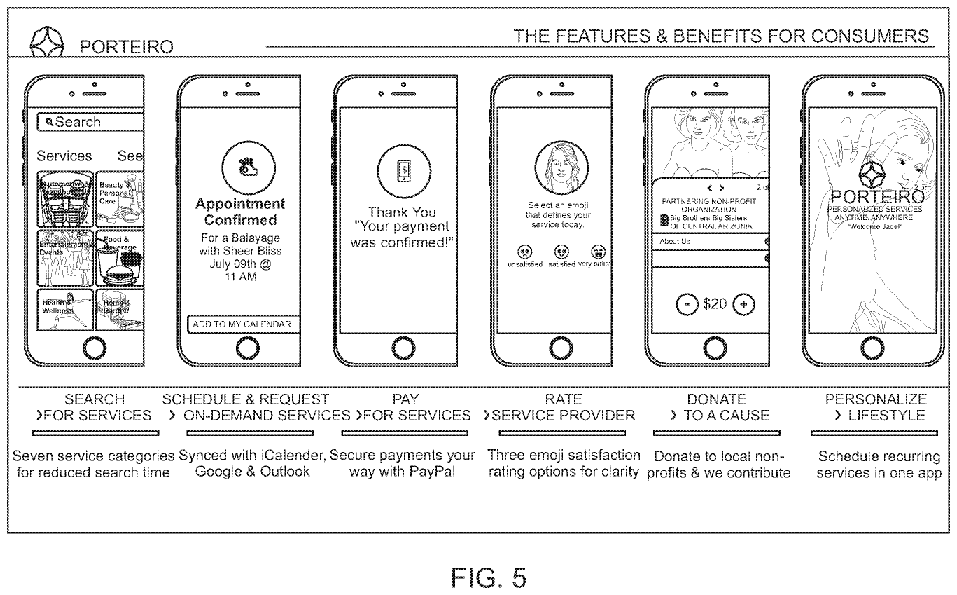

FIG. 3 is a flow diagram illustrating the operation of the system from a consumer standpoint in an embodiment. At step 301 the consumer searches for desired services. In this step, the consumer might indicate a required time for service, e.g. for on-demand service such as a haircut at home. The consumer may also indicate a price range, skill set, credential requirement, language requirement, and the like. There are other options that the consumer can set as desired. FIG. 5 is an illustration of examples of the consumer facing application on a smartphone.

At step 302 the system applies AI to provide suitable options to the consumer based on the consumer's choices and filters. The system will check the proximity of service providers to determine which ones can meet the appointment deadline. This may be via GPS tracking of the service providers to determine their location relative to the consumer location. The system then determines if the service providers are available to travel to the requested appointment. For example, the system may be aware that some service providers are either in the middle of an appointment or heading to another appointment, or have a previously scheduled appointment that would prevent them from performing the requested service.

When the system has identified all possible service providers who can meet the consumer request, the system presents the options to the consumer at step 302 and the consumer chooses a provider and schedules the service.

At step 303 the service is performed and the consumer provides payment. In one embodiment, an authorization is requested from the Consumer's method of payment that is on file at the time of service request selection, and funds are then processed by the system's payment processor, released to a system account and then we send payments to the service providers via PayPal Payout. This can be completed through any payment provider. A commission is charged over the standard fee of the service provider in one embodiment. The commission may be 5% per requested service in one embodiment. The payment is made through the system in one embodiment. The user account may include credit card or other payment information and the system presents a charge to the consumer and the consumer can authorize the charge.

At step 304 the consumer rates the service provider. At step 305 the system updates the consumer profile based on the service request and performance, and personalizes the consumer profile to provide improved service in the future, including anticipating service needs of the consumer. For example, if the consumer gets a haircut every three weeks, the system can begin sending reminders to the consumer and offering appointments in advance. The service providers may be able to offer discounts to consumers who have regular service in an attempt to obtain a customer. The system may do this automatically for the service provider based on the subscription level of the consumer.

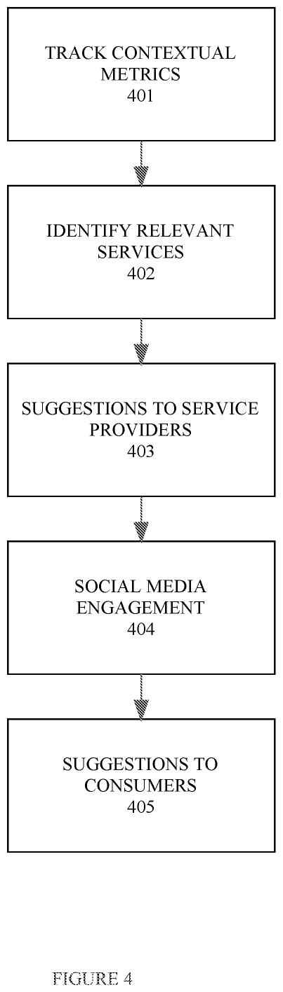

The system uses predictive analytics and artificial intelligence to provide suggestions of services and service providers to consumers. The same analytics can be used to assist service providers on pricing, hours, scheduling, services and the like. FIG. 4 is a flow diagram illustrating the operation of the predictive analytics of the system in an embodiment.

At step 401, the system tracks contextual metrics to use in providing service suggestions to consumers. Contextual metrics including, but not limited to the weather, day of week (weekday vs weekend); date (upcoming holidays, birthdays, three-day weekends); local events (concerts, sporting events including playoffs, critical games, rivalry games, farmer's markets; festivals; sales; traditions; and the like); and seasonal events (prom, lawn mowing season; produce harvest times such as heirloom tomatoes, copper river salmon, spiny lobster, stone fruit, and the like)

At step 402 the system applies heuristic information, histogram information, machine learning, historical data, artificial intelligence, and behavioural and predictive analytics to identify services that are most appropriate for the current and predicted contextual metrics. For example, car washing may be popular right after rain (but not before). Limo rentals peak during prom season. Hair styling is popular before and during holiday season, gardening is most needed in the summer months. Catering is popular during the Super Bowl, Oscars, etc. The system has a greater breadth of data available about the consumer, so more accurate behavioural and predictive analytics can be performed by the system.

At step 403 the system may make suggestions to local service providers to be aware of the contextual metrics and focus on the services with the highest need at that time. The service providers may want to adjust prices up or down depending on the contextual metrics. At step 404 the system may automatically initiate appropriate social media engagement to help prime the consumers for the offered services.

Finally, at step 405, the system may make direct suggestions to consumers through social media, email, texts, and the like.

In one embodiment, the system uses voice technology for ordering and accepting services and orders. For example, the system may be activated by a trigger phrase. At that time, the consumer may use voice to request services, either in general or from a specific provider. The system will respond accordingly with suggestions of a provider and/or request clarification as to date and time of service.

In one embodiment, the system may provide an oral query to the consumer when a recurring service is due or needs to be confirmed. In one embodiment, the user can set up auto-scheduled services on a recurring basis using voice commands. Thus, an improved method and apparatus for delivery of services has been described.

What is claimed is:

1. A method of delivering services comprising:
identifying contextual metrics related to a user;
applying machine learning and histogram information to identify services appropriate for the identified contextual metrics;
providing suggested services to the user based on the contextual metrics and machine learning;
alerting service providers of the contextual metrics to allow the service providers to adjust services and prices based on the contextual metrics.

2. The method of claim 1 wherein the contextual metrics comprise weather, date, day of week, local events; or seasonal events.

3. The method of claim 1 wherein the service providers increase prices when contextual data indicates increased demand for services.

4. The method of claim 1 wherein the histogram information is generated by the history of the user.

5. The method of claim 1 wherein payment from the user is to a system and payment to the service providers is from the system.
